(19) United States
(12) Patent Application Publication
(10) Pub. No.: US 2007/0283274 A1
(43) Pub. Date: Dec. 6, 2007

(54) Strategies for Providing a Customized Media Presentation Based on a Markup Page Definition (MPD)

(75) Inventor: Gionata Mettifogo, Menlo Park, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/420,998

(22) Filed: May 30, 2006

(51) Int. Cl. G06F 9/00

(52) U.S. Cl. 715/744

(57) ABSTRACT

Strategies are described for providing a media presentation based on a markup page definition (MPD). In operation, an operations center provides an MPD in response to a triggering event. The MPD may be expressed as an HTML page. The MPD includes one or more references to respective media streams. A client device renders a media presentation based on the MPD. For instance, the client device accesses the media streams referenced by the MPD by virtually tuning to and receiving these media streams. The strategies can be applied in various scenarios. For instance, the strategies can be applied to generate a media presentation of locale-specific programs or channels, recently viewed programs or channels, favorite programs or channels, popular programs or channels, and so on.

### BACKGROUND

FIG. 1 shows a conventional technique for providing a media presentation, where the media presentation is an integrated (i.e., single) composite of two original video streams. For instance, this technique may be employed in any circumstance in which it is desirable to “superimpose” the presentation of one video program onto another. In one such circumstance, a program may show a live broadcast of a sporting event in a principal part of its presentation, while showing a replay of an interesting play in a sub-picture that is superimposed over the principal part of the presentation.

To implement this conventional technique, an operations center 102 may include a video integration module 104. The video integration module 104 combines together 11 two or more video streams 106. The video integration module 104 produces a single channel 108. The content of the single channel 108 includes a combination of the video streams 106. The operations center 102 may broadcast the single channel 108 on a single assigned frequency.

A client device 110, such as a set-top box, receives the single channel 108 in a conventional manner by tuning to the frequency of the single channel 108 using a physical tuner 112. The client device 110 outputs a media presentation 114. The media presentation 114 is a composite of the multiple video streams 106. For example, in the representative case of FIG. 1, the media presentation 114 includes a first media presentation (representing the content of a first video stream) and a second presentation (representing the content of a second video stream). However, despite the visual appearance of two separate media presentations, the composite media presentation 114 actually represents a single program like any other program delivered via a single channel.

While the above technique has proven useful, it does not provide a particularly versatile method for combining video streams together. For at least this exemplary reason, there is a need for a more effective technique for creating a media presentation that includes component parts.

### SUMMARY

The following description sets for strategies for providing a media presentation based on a markup page definition (MPD). In operation, an operations center provides an MPD in response to a triggering event. The MPD may be expressed as a Hypertext Markup Language (HTML) page. The MPD includes one or more references to respective media streams. The MPD (and its associated references) can be customized for a particular target client device. Upon receipt, the client device renders a media presentation based on the MPD. To perform this task, the client device accesses the media streams referenced by the MPD by virtually tuning to and receiving these media streams. More specifically, in one case, the client device includes a browser which interprets markup information in the MPD to access the media streams. In another case, a conversion tool is used to convert the MPD into a modified form which is tailored to suit the capabilities of the client device, and the client device renders the media presentation based on the modified form of the MPD.

The strategies can be used in various applications. According to one example, the operations center can generate an MPD that includes references to programs that pertain to a specific locale, such as weather programs which pertain to a particular region of the country. According to another example, the operations center can generate an MPD that includes references to programs or channels that the user has recently viewed. According to another example, the operations center can generate an MPD that includes references to programs or channels that a user has earmarked as “favorites.” According to another example, the operations center can generate an MPD that includes references to programs that have been assessed as popular among a defined group (such as users of a particular geographic group or interest group). According to another example, the operations center can generate an MPD that includes references to programs that pertain to an identified topic (such as sports-related programming). These are representative applications. Still other applications are possible.

The strategies summarized above confer a number of exemplary advantages. According to one advantage, the strategies provide a versatile technique for generating a media presentation having component parts. Due to its versatility, the strategies can be more easily adapted for use in different applications. According to another advantage, the strategies provide media presentations having component parts that are tailored to different end users. According to another advantage, the strategies can provide a media presentation having component parts which represent separate streams with which the user may separately interact. The strategies may confer yet additional features and benefits.

This Summary section refers to exemplary manifestations of the subject matter described herein, and hence does not limit the scope of the invention set forth in the Claims section.

### BRIEF DESCRIPTION OF THE DRAWINGS

FIG. 1 shows an example of a known technique for producing and consuming a single stream that combines multiple component parts.

FIG. 2 shows an overview of an exemplary system for rendering a media presentation based on a markup page definition (MPD), including an operations center and a representative client device.

FIG. 3 shows a page creation module that can be used in the system of FIG. 2.

FIG. 4 shows processing functionality that can be used to implement any aspect of the operations center of FIG. 2.

FIG. 5 shows processing functionality that can be used to implement any aspect of the client device of FIG. 2.

FIGS. 6 and 7 show a procedure for creating an MPD according to two different respective scenarios.

FIG. 8 shows a procedure for generating a media presentation based on an MPD.

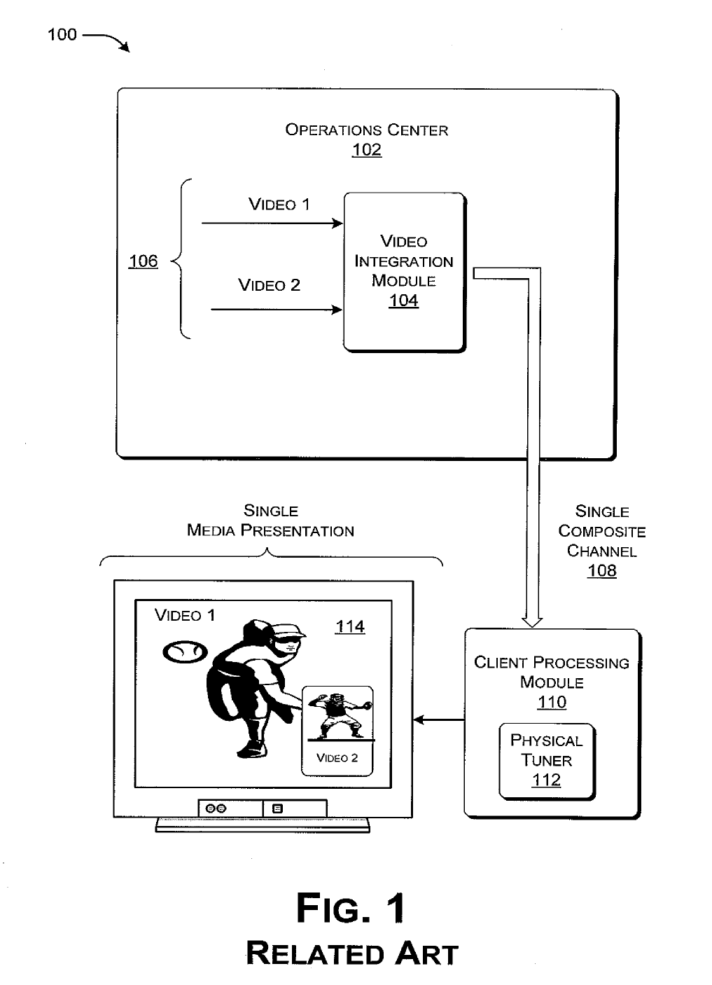

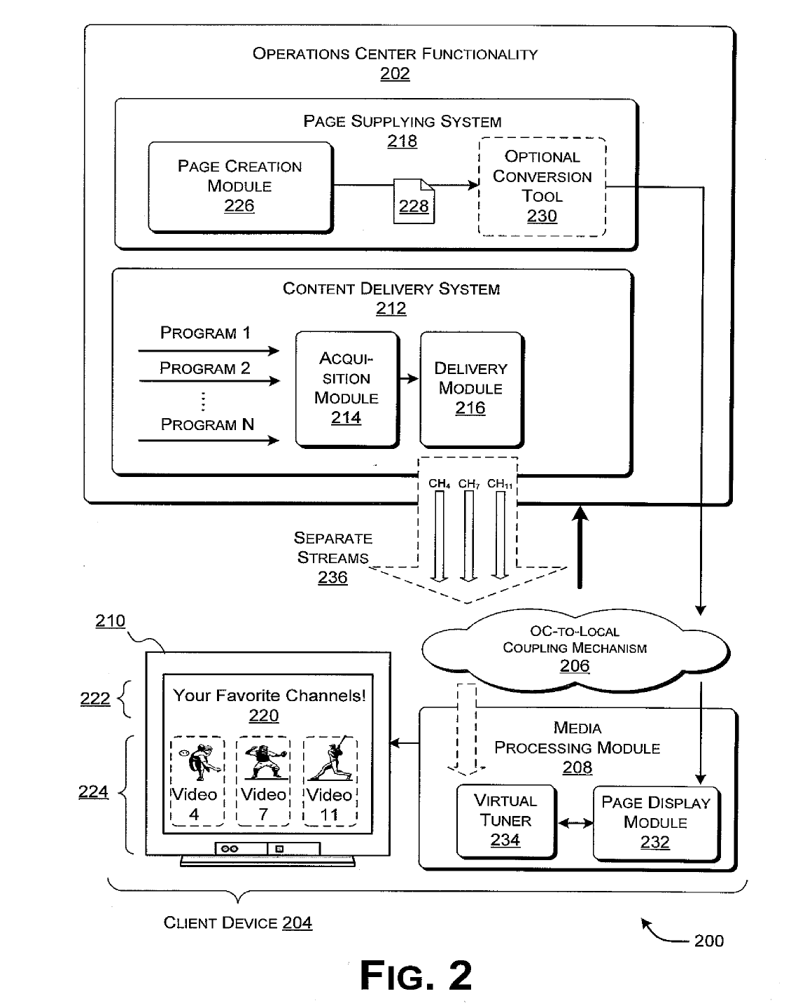

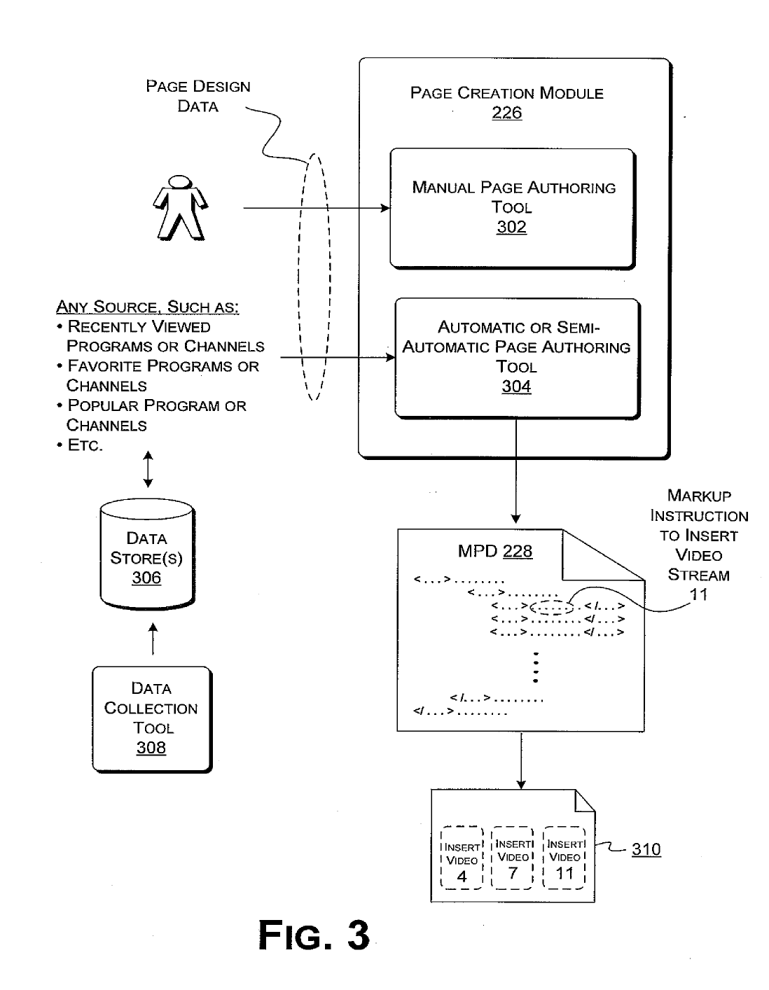

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

The following description sets forth strategies for creating a media presentation that includes plural component parts based on a markup page definition (MPD). The strategies are manifested in systems, computer-readable media, methods, and so on.

This disclosure includes the following sections. Section A sets forth an exemplary system for producing a media presentation based on an MPD. Section B sets forth exemplary procedures which explain the operation of the system of Section A. Section C describes various applications of the system of Section A.

A. Exemplary System (FIGS. 2-5)

Generally, any of the functions described with reference to the figures can be implemented using software, hardware (e.g., fixed logic circuitry), manual processing, or a combination of these implementations. The term “logic”, “module” or “functionality” as used herein generally represents software, hardware, or a combination of software and hardware which can be configured to implement prescribed functions. For instance, in the case of a software implementation, the term “logic,” “module,” or “functionality” represents program code (and/or declarative-type instructions) that performs specified tasks when executed on a processing device or devices (e.g., CPU or CPUs). The program code can be stored in one or more computer readable memory devices.

More generally, the illustrated separation of logic, modules, and functionality into distinct units may reflect an actual physical grouping and allocation of such software and/or hardware, or can correspond to a conceptual allocation of different tasks performed by a single software program and/or hardware unit. The illustrated logic, modules and functionality can be located at a single site (e.g., as implemented by a processing device), or can be distributed over plural locations.

The term “machine-readable media” or the like refers to any kind of medium for retaining information in any form, including various kinds of storage devices (magnetic, optical, static, etc.). The term machine-readable media also encompasses transitory forms for representing information, including various hardwired and/or wireless links for transmitting the information from one point to another.

A.1. Overview of One Exemplary System (FIG. 2)

FIG. 2 shows one media streaming system 200 for producing a media presentation having multiple component parts based on a markup page definition (MPD). The multiple component parts may comprise different respective media streams. The media streams, in turn, may pertain to audio-visual media presentations, music, games, and so on. In this sense, the media presentation can be viewed as a mosaic of smaller component media presentations, organized into a page that pertains to a prescribed theme.

The system 200 includes an operations center 202 for handling various server-side aspects of the system. The operations center 202 communicates with a plurality of client devices, such as exemplary client device 204, via a coupling mechanism 206. In the following discussion, explanation of the composition and behavior of the representative 8 client device 204 applies to any number of client devices that are not shown in FIG. 2.

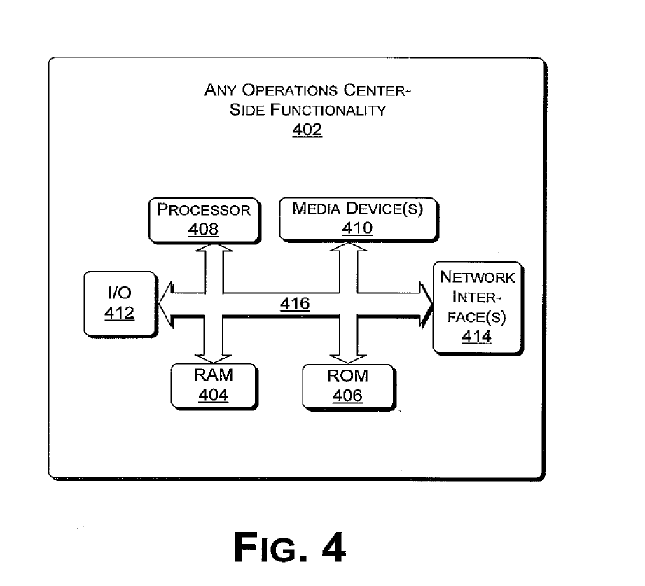

The operations center 202 can be implemented by one or more server computers, databases, and other data handling equipment. The components of the operations center 202 can be located at a single site or distributed over plural sites. Further, the components of the operations center 202 can be administered by a single entity or plural cooperating entities. FIG. 4, to be discussed in greater detail below, shows the exemplary architecture of processing functionality that can be used to implement any aspect of the operations center 202.

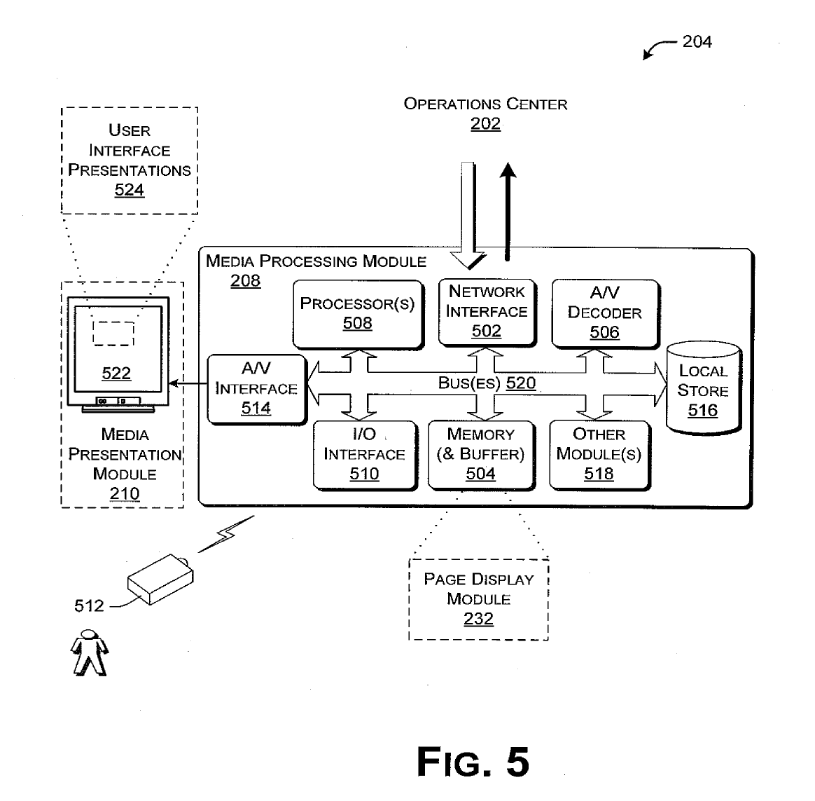

The representative client device 204 can represent a television set with integral IP interfacing/processing functionality, a television set with an associated set-top box coupled thereto, a digital video recorder (DVR) device, a rewritable digital video disc (DVD-RW) device, a personal computer having AV processing functionality, a music playback system, a portable personal media device, a mobile telephone, a game console, and so forth (as well as any combination of these devices). In whatever manner implemented, the representative client device 204 can comprise a media processing module 208 that is communicatively coupled to a media presentation module 210. FIG. 5, to be discussed in greater detail below, shows the exemplary architecture of processing functionality that can be used to implement the client device 204.

The coupling mechanism 206 couples the operations center (OC) 202 to the representative client device 204, and is therefore labeled in FIG. 2 as an OC-to-local coupling mechanism. This coupling mechanism 206 can be implemented in different ways to suit different technical and commercial environments. For instance, the coupling mechanism 206 can include any kind of network (or combination of networks), such as a wide area network (e.g., the Internet), an intranet, Digital Subscriber Line (DSL) network infrastructure, point-to-point coupling infrastructure, and so on. The coupling mechanism 206 can use or involve any kind of protocol or combination of protocols. In the case in which one or more digital networks are used to disseminate information, the coupling mechanism 206 can include various hardwired and/or wireless links, routers, gateways, name servers, and so on. In the case where DSL infrastructure is used to disseminate information, the coupling mechanism 206 can utilize the services, in part, of telephone coupling infrastructure and DSL processing functionality.

Now referring to the exemplary composition of the operations center 202 in greater detail, the operations center 202 can include a content delivery system 212. The purpose of the content delivery system 212 is to delivery streams of media information to the client device 204 via the coupling mechanism 206. To function in this manner, the operations center 202 includes an acquisition module 214 for supplying programs from one or more sources of such information, and for optionally performing preliminary processing on the programs (such as by converting the programs into a uniform format for dissemination to the client device 204). The sources can represent any kind of entity which produces or provides media information, such as cable or satellite television providers, one or more Video-On-Demand (VOD) providers, one or more publishing houses of information, one or more library sources, any kind of Internet-enabled repository, and so on. The acquisition module 214 can be implemented by one or more server computers or other functionality (not shown).

The content delivery system 212 can also include a delivery module 216 for streaming media information to the client device 204 via the coupling mechanism 206. The delivery module 216 can be implemented as a collection of server computers or other functionality. One specific but non-limiting implementation of delivery module 216 is described in copending and commonly assigned U.S. patent application Ser. No. 10/010,200, entitled, “Accelerated Channel Change in Rate-Limited Environments,” naming the inventors of Geoffrey R. Smith et al., filed on Dec. 10, 2004, which is incorporated herein by reference in is entirety.

The system shown in FIG. 2 includes one or more downlink paths and one or more optional uplink paths. The downlink paths are used to forward media programs to the client device 204. The uplink paths can be used to forward user selections and other information to the operations center 202. The uplink and downlink paths can be implemented by the same communication mechanism, or by different respective communication mechanisms.

The operations center functionality 202 also includes a page supplying system 218. The page supplying system 218 can be implemented by the same equipment that implements the content delivery system 212, or by different equipment (or by some hybrid of these two different cases). Further, the page supplying system 218 can be administered by the same entity that implements the content delivery system 212, or by a different entity. Further, the page supplying system 218 can be located at the same site as the content delivery system 212 or at a different site.

The page supplying system 218 includes a page creation module 226. The purpose of the page creation module 226 is to create a markup page definition (MPD) 228. As the name suggests, the MPD 228 may comprise information expressed in a declarative markup language, such as, but not limited to, the Hypertext Markup Language (HTML). The markup information in the MPD 228 contains instructions that define the visual appearance and other aspects of a media presentation to be displayed by the client device 206.

For example, consider the illustrative case of the exemplary media presentation 220 being displayed by the client device 204. This media presentation 220 includes a caption 222 that reads, “Your Favorite Channels,” which informs the viewer that the media presentation 220's purpose is show samples of the viewer's favorite channels. The media presentation 220 also includes plural video presentations 224, which, in this case, show the content being delivered by three of the user's favorite channels. Therefore, in this particular scenario, the MPD 228 includes an instruction to present the textual caption 222. The MPD 228 can delimit the textual caption by appropriate markup tags. The MPD 228 can also include instructions to present three video presentations 224 at prescribed locations in the media presentation 220. The MPD 228 can identify the video presentations 224 by including appropriate references to the video presentations 224, delimited by appropriate markup tags.

Note that the use of the term “page” here does not necessarily imply that the media presentation 220 specified by the MPD 228 is limited to a single displayed page of information. The term “page” very generally refers to any collection of information that is used to produce any kind of display. For instance, the MPD 228 may include instructions which define the appearance of multiple displayable pages of the media presentation 220, and so on.

In those circumstances in which the client device 204 includes browser-like functionality that is able to interpret a HTML MPD 228, then the page supplying system 218 can forward the original MPD 228 to the client device 204. In other scenarios, the client device 204 may not be able to interpret the MPD 228, due, for instance, to processing limitations and others factors. In this case, the page supplying system 218 can optionally include a conversion tool 230. The conversion tool 230 converts the MPD 228 into a form that the client device 204 can interpret. The specific nature of the conversion tool 230 varies depending on the characteristics and capabilities of the client device 204 which is to receive the MPD 228.

In one case, the conversion tool 230 can include functionality which converts HTML information into Extensible Markup Language (XML) information. The conversion tool 230 can also produce images (such as JPEG images), which accompany the XML information. The tool 230 generates the images to duplicate parts of the media presentation that is described by the HTML information in the MPD 228. By producing this kind of modified form of the MPD 228, the client device 204 can render the media presentation 220 without having to interpret HTML information.

Now referring to the client-side aspects of the system 200, the client device 204 can include, among other components, a page display module 232. The purpose of the page display module 232 is to receive the MPD 228, interpret it, and produce the media presentation 220 based on such processing. As explained above, in one implementation, the client device 208 can include browser-like functionality. In this case, the page display module 232 can interpret HTML instructions in the MPD 228. In another case, the client device 204 may not be able to interpret HTML instructions. In this case, the page display module 232 processes the MPD 228 in whatever modified form it is provided by the conversion tool 230 (where such form is environment-specific).

As described above, the MPD 228 includes references to one or more video programs that should be presented at defined locations within the media presentation 220. The page display module 232 receives these references, and based on these references, accesses one or more video streams associated with the programs being referenced. To perform this function, the page display module 232 interacts with a virtual tuner 234. The virtual tuner 234 “tunes” to the video streams identified by the references. In one exemplary implementation, tuning can comprise accessing one or more multicast sources (e.g., by specifying the addresses of such multicast sources). One known way of receiving multicast content is by using the Internet Group Multicast Protocol (IGMP).

The virtual tuner 234 is referred to as “virtual” in the sense that it does not tune to a frequency that is being used to transmit a single channel, as in the traditional case of FIG. 1. Because the virtual tuner 234 is not implemented by a physical tuner, there is theoretically no limit to the number of video streams that it can receive. The virtual tuner 234 is potentially limited only by bandwidth constraints which define the total of amount of information that it can receive and process at any one instance. Further details regarding one technique for receiving plural streams of information using a virtual tuner is described in copending and commonly assigned U.S. patent application Ser. No. 11/057,477, entitled, “Tunerless Media Presentation Unit and Methods of Use,” naming the inventors of David L. de Heer et al., filed on Feb. 14, 2005, which is incorporated herein by reference in its entirety.

As a result of the operation of the page display module 232 and the virtual tuner 234, the client device 234 can receive plural video streams 236 at the same time. Unlike the conventional case (of FIG. 1), the plural video streams 236 comprise separate programs, possibly being transmitted over plural channels.

The result of the operation of the system 200 is the production of the media presentation 220. One exemplary media presentation 220 was described above, including a caption 222 and multiple video streams 224. The video streams may comprise picture-in-picture (PIP) presentations of moving video content. The video streams can be selected to have any size, resolution, frame rate, and so on. Instead of motion video streams, the media presentation 220 can include thumbnail presentations that include representative frames from the video streams (which can alternatively be periodically updated at a defined rate). Still other display options are possible. One exemplary technique for displaying a media presentation based on markup content is described in U.S. patent application Ser. Nos. 10/892,705, 10/892,917, and 10/893,714, all entitled, “Document Data Structure and Method for Integrating Broadcast Television with Web Pages,” all naming the inventors of Daniel J. Zigmond et al., all filed on Jul. 16, 2004, and which are all incorporated herein by reference in their respective entireties.

According to another feature, the user can interact with separate video streams. For instance, when the user selects one of the video streams 224, the system 200 can be configured to display the selected stream as the principal video stream, or the system 200 can be configured to perform some other function associated with the selected stream.

In the particular scenario of FIG. 2, the goal of the media presentation 220 is to display the favorite programs or channels of the user. However, this is merely one of many possible applications. Section C (below) sets forth additional applications.

A.2. Page Creation Module (FIG. 3)

FIG. 3 illustrates the exemplary makeup of the page creation module 226 in greater detail. By way of overview, in one mode, the page creation module 226 can rely on a manual authoring tool 302 that allows a human user to manually create the markup page definition (MPD) 228. In another mode, the page creation module 226 can rely on an automatic or semiautomatic page authoring tool 304 that creates the MPD 228 in an automatic or semiautomatic manner.

The manual page authoring tool 302 can represent any functionality that allows a user to write markup instructions that define the layout of a desired MPD 228. For instance, such manual page authoring tool 302 can include a text editor. The manual page authoring tool 302 can include other conventional functionality, such as debugging tools, page presentation preview tools, and so forth.

The automatic or semiautomatic authoring tool 304 (referred to for brevity as an “automatic page authoring tool”) can represent any functionality for automatically (or semi-automatically) constructing the MPD 228. The nature in which the MPD 228 is constructed depends on the function that the MPD 228 fulfills in a specific scenario. In general terms, in one case, the automatic page authoring tool 204 may construct the MPD 228 based on data collected in a data store 306 by a data collection tool 308.

For example, assume that the purpose of the MPD 228 is to display an array of video streams that represent the last five channels that the user has visited. In this case, the data collection tool 308 collects channel selections made by the user. Or assume that the purpose of the MPD 228 is to display an array of video streams that represent the user's favorite channels. In this case, the data collection tool 308 collects preference information expressly identified by the user. Or the MPD 228 can infer the preferences of the user based on common types of selections made by the user. In another case, assume that the purpose of the MPD is to display an array of video streams that are popular within a certain group. In this case, the data collection tool 308 collects selections made by an identified group of users (such as the users in a particular geographic region). Section C expands on the above scenarios, and also describes additional scenarios.

In any event, the automated page authoring tool 304 can retrieve the data stored in the data store 306 and apply it to produce the MPD 228. For example, assume that the purpose of the MPD 304 is to show the last five channels that the user has viewed. The automated page authoring tool 304 can determine reference data that corresponds to the five channels and then embed this reference data into the MPD 228. This kind of authoring tool 304 may be semi-automated in the sense that some aspects of the media presentation 220 may be manually defined by a user. For instance, a human user may manually define how the video streams are arranged in the media presentation 220. A human user may also manually define various textual captions, graphics, and other information that may accompany the presentation of the video streams. In other words, a human user may manually define a skeleton framework of the media presentation 220, and the automatic authoring tool 304 may then automatically and dynamically insert video stream references into the framework, depending on user selections and/or other variable data.

In general terms, in either the manual mode or the automatic mode, the page creation module 226 can be said to accept page design data and to create the MPD 228 based, in part, on the page design data. The page design data can reflect locale-specific information, user media selection information, user-specified favorite information, popularity information, and so on. Based on the page design data, the page creation module 226 can create the MPD 228 so that it is customized for a particular client target 19 device.

FIG. 3 also generally shows the exemplary makeup of the MPD 228. As explained above, the MPD 228 can include markup language content (such as HTML content). Tags can be defined to demarcate visual elements within the media presentation 220, such as text, graphics, video streams, and so forth. The resultant MPD 228 constitutes declarative instructions which direct the page display module 232 of the client device 204 to construct the defined media presentation 220 for output to the user. The above-described Zigmond et al. Patent Applications provide one exemplary way of structuring references to media information within a markup page.

A structure 310 depicted at the bottom of FIG. 3 graphically represents the kind of a MPD-defined skeleton framework mentioned above. The authoring tool 304 may automatically and dynamically insert video stream references, depending on user selections and/or other variable data, into this structure 310.

A.3. Alternative Implementation: Local Page Supplying System

Although the above explanation describes the page supplying system 218 as part of the operations center 202, this represents only one exemplary implementation. In another implementation, the page supplying system 218 can be part of the client device 204, or at least part of equipment that is local with respect to the client device 204. In this case, the client device 204 itself can construct the MPD 228 used to create the media presentation 220.

In still another example, aspects of the page supplying system 218 can be shared between the operations center 202 and the client device 204. For instance, a server-side page supplying system 218 can forward a basic framework that defines how to construct the MPWD 228. A client-side page supplying system 218 then receives data that is used to customize the basic framework to produce a final MPD 228. This implementation therefore may not require transmitting user selections from the client device 204 to the operations center 202. For example, consider the case in which the goal is to produce a media presentation 220 that displays the user's five most recent channel selections. The operations-side page supplying system 218 can provide a basic HTML framework that generally describes how to organize the favorite channel sub-presentations within the overall media presentation 220. A client-side page supplying system 218 can then locally receive the user's selections, and based on these selections, modify the MPD 228 to include references to the most recently viewed N channels.

A.4. Operations Center-Side Processing Functionally (FIG. 4)

Various components of the operations center 202 shown in FIG. 2 can be implemented by processing equipment, such content delivery system 212 (an its individual components) and the page supplying system 218 (and its individual components). For example, these components can be implemented as one or more server computers, storage mechanisms, and other processing equipment. FIG. 4 shows a general depiction of processing functionality 402 that can be used to implement any of components of the operations center 202.

The processing functionality 402 can include various volatile and non-volatile memory, such as RAM 404 and ROM 406, as well as one or processing devices 408. The memory (404, 406) can store instructions which perform the various functions described above when executed by the processing devices 408. The processing functionality 402 also optionally includes various media devices 410, such as a hard disk module, an optical disk module, and so forth. The processing functionality 402 also includes an input/output module 412 for receiving various inputs from the user (as implemented by a key input mechanism, etc.), and for providing various outputs to the user (as implemented by various display devices, printers, audio output devices, etc.). The processing functionality 402 can also include one or more network interfaces 414 for exchanging data with other devices. One or more communication buses 416 communicatively couple the above-described components together.

In various applications, the processing functionality 402 shown in FIG. 4 can include additional modules or can omit one or more of the modules shown in FIG. 4.

A.5. Exemplary Client-Side Processing Equipment (FIG. 5)

FIG. 5 provides additional details regarding the representative client media device 204. In general, a client device 204 can include the above-referenced media processing module 208 and a media presentation module 210. The role of the media processing module 208 is to perform various processing operations on a received media resource. The role of the media presentation module 210 is to present the processed media resource.

The media processing module 208 can include a number of modules for performing its ascribed tasks. To begin with, the media processing module 208 includes a network interface module 502. The network interface module 502 can represent any functionality for receiving media information from the operations center 202 using any coupling mechanism. For example, the network interface module 502 can comprise an Ethernet NIC, a DSL modem, a cable modem, a wireless network interface, or other kind of network interface equipment.

The media processing module 208 also includes memory 504. A portion of the memory 504 can optionally comprise program instructions for implementing any aspect of client-side page handling functionality, such as the page display module 232.

The media processing module 208 also includes an audio-visual (AV) decoder 506 for decoding (and decompressing) the received media resource into its video and audio components. Decoding comprises ordering packets (if received out of order), extracting media information from the stream of received packets, and also extracting timing information that will govern the playback of the media resource. Together, the network interface 502 and the AV decoder 506 can implement the virtual tuner 234 of FIG. 2.

The media processing module 208 also includes one or more processors 508 for executing instructions to implement the functionality of the media processing module 208.

The media processing module 208 also includes an I/O interface 510 for interacting with the user via one or more input devices, such as a remote controller 512, a personal computer (not shown), a joy stick (not shown), a voice recognition mechanism (not shown), and so forth.

The media processing module 208 also includes an AV interface module 514 for providing media information in an appropriate format to the media presentation module 210.

The media processing module 208 can also include a media content store 516 for storing recorded resources and other data. More specifically, this media content store 516 can be integrated with the media processing module 208 itself, or can represent part of a separate recording device, with which the media processing module 208 interacts.

Finally, the client processing module 208 can include various other modules 518, not specifically identified by name in the figure. For instance, the media processing module 208 can include a graphics compositor for combining a video component of the media information from the AV decoder 506 on a frame-by-frame basis with graphics information. The graphics information may comprise various user interface presentations which are overlaid on the media information.

One or more busses 520 communicatively couple the above-identified components together

The media presentation module 210 can comprise any kind of device for presenting AV information, including a CRT-type device, an LCD-type device, and so forth. In any case, the media presentation device 210 defines a display surface 522. The media processing module 208 can present one or more user interface presentations 524 on the display surface 522. Once again, the organization and content of information presented on the display surface 522 is governed by the markup page definition (MPD) created by the page supplying system 218 of the operations center 202.

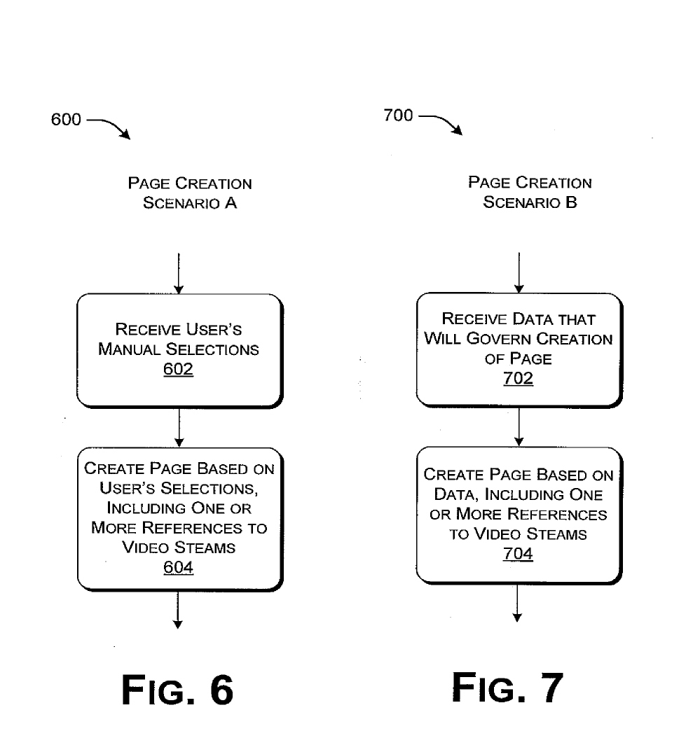

B. Exemplary Method of Operation (FIGS. 6-8)

FIGS. 6-8 describe the operation of the system 200 in flowchart form. To facilitate discussion, certain operations are described as constituting distinct steps performed in a certain order. Such implementations are exemplary and non-limiting. Certain steps described in these flowcharts can be grouped together and performed in a single it operation, and certain steps can be performed in an order that differs from the order shown in the flowcharts. As the functions described in these flowcharts have already been explained in Section A, this section will serve primarily as a review of those functions.

B.1. Creating the MPD (FIGS. 6 and 7)

FIG. 6 shows a procedure 600 which broadly outlines the steps involved in manually creating a markup page definition (WD) 228. In step 602, the user's selections are received. This may involve receiving the user's input via a text editor to create an HTML document. In step 604, the manual authoring tool 302 (of FIG. 3) creates the MPD 228 based on the user's inputs.

FIG. 7 shows a procedure 700 which broadly outlines the steps involved in automatically or semi-automatically creating the MPD 228. In step 702, various data is optionally collected that will govern the creation of the MPD 228. Such data, as explained in the context of FIG. 3, may comprise data gleaned from the user's channel or program selections, data gleaned from the user's specified preferences, data collected from an identified group of users, and so forth. In step 704, the automatic authoring tool 304 (of FIG. 3) creates the MPD 228 based on the collected data.

In both FIGS. 6 and 7, the page creation module 226 can generally be said to create the MPD 228 based on page design data. The page design data reflects any information that governs the selection of media streams for inclusion in the MPD 228, where such selection can be tailored to suit a given target client device.

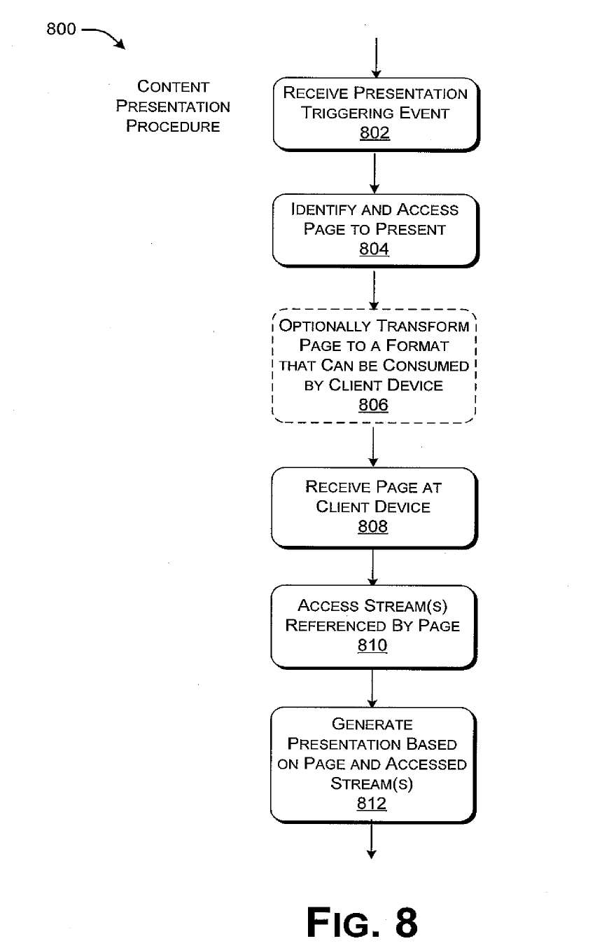

B.2. Providing a Media Presentation Based on the MPD (FIG. 8)

FIG. 8 shows a procedure 800 for generating a media presentation based on an MPD 228.

Steps 802-806 define operations that may optionally be performed by the operations center 202. In step 802, the page supplying system 218 receives a triggering event. The triggering event triggers the display of media presentation 220 based on the MPD 228. This event may be an express instruction by the end user to display the media presentation 220, such as a request to display the N most recently viewed channels, a request to display the user's favorite channels, a request to display the most popular channels among a defined group, and so on. Alternatively, the system 200 may be configured to automatically present certain media presentations 220 without receiving express instructions from the end user. For example, the system 200 may present a media presentation that features the user's favorite channels or the user's recently viewed channels when the user first turns on her television (without being prompted to do so by the user). In step 804, based on the triggering event, the page supplying system 218 accesses an appropriate MPD 228. In step 806, the conversion tool 230 optionally transforms the page into a format that can be consumed by the client device 204. This is appropriate, for instance, when the client device 204 does not have the capability of interpreting HTML declarative content.

Steps 808-812 define operations that may be performed by the client device 202. In step 808, the page display module 232 of the client device 204 receives the MPD 228. In step 810, in the course of processing the MPD 228, the page display module 232 accesses one or more video streams that are referenced by the MPD 228. The page display module 232 can perform this task with the assistance of the virtual tuner 234. In step 812, the page display module 232 finalizes the media presentation 220 based on the instructions in the MPD 228 and the accessed video streams, and displays the media presentation 220.

C. Exemplary Applications

As noted above, the system 200 shown in FIG. 2 can be used in many different applications. This section describes representative applications.

C.1. Locale-Specific Presentations.

In a first application, the system 200 can present a locale-specific media presentation 220. For example, when a user who lives the Pacific Northwest activates a weather report service, the page supplying system 218 detects the locale of the user (e.g., based on locale information embedded in the client device's request message). The page supplying system 218 can then create a MPD 228 that includes identifiers that reference one or more weather-related video streams pertinent to the Pacific Northwest. In any of the scenarios described in this section, the MPD 228 may also include textual and/or graphical information associated with a particular kind of media presentation 220. For example, in this case, the MPD 228 may display a caption that identifies the weather report as a report for the city of Portland, Oreg. The page display module 232 at the client device 204 then produces the media presentation 220 that includes the weather-related video streams referenced by the MPD 228.

C.2. Channel Refresh.

In another application, the system 200 keeps track of the channel and/or program selections made by a user. When user activates a refresh command (e.g., on the remote controller 512), or based on some other triggering event, the page supplying system 218 creates a MPD 228 that references the last N channel selections and/or program selections made by a user. The page display module 232 then produces the media presentation 220 based on the channel refresh MPD 228 in the manner described above. This type of media presentation 220 is specifically tailored to an individual user, as it presents video streams based on a specific user's selections.

C.3. Favorite Channels.

In another application, the system 200 keeps track of the user's favorite channels or programs. For example the user may create a profile, part of which identifies the user's favorite channels or programs. Or the system 200 can independently assess the preferences of the user by monitoring common selections made the user. When the user activates a favorite command (e.g., on the remote controller 512), the page supplying system 218 creates a MPD 228 that includes identifiers that reference the user's favorite channels or programs. Or the system 200 can automatically provide the MPD 228 (that is, without receiving an express request from the user). Upon receipt of the MPD 228, the page display module 232 produces the media presentation 220 that includes the favorite video streams referenced by the MPD 228. Like the case of the refresh media presentation, this type of media presentation is specifically tailored to an individual user, as it presents video streams based on a specific user's selections.

C.4. Popular Channels.

In another application, the system 200 keeps track of the channels that are assessed as being popular among an identified group of users. For example, the system 200 can monitor the selections made within a particular household, within a particular neighborhood, city, state, country, and so forth. Or the system 200 can monitor the selections made within a particular interest group, such as users who have previously registered an interest in adventure movies, and so on. Based on these selections, the system 200 can determine which channels or programs are the most popular in the identified group (based on which channels or programs are most frequently watched by the users). Then, when the user activates a “show me popular items” command, or based on an automatic triggering event, the page supplying system 518 creates an MPD 228 that includes identifiers that reference the popular channels or programs. The page display module 232 then produces a media presentation 220 that includes the popular video streams referenced by the MPD 228. This type of media presentation is specifically tailored with respect to members of a group, such that members of one group may receive a different media presentation than members of another group.

C.5. Channels Grouped by Subject

In another application, the system 200 can group channels or programs into different categories depending on attributes associated with the channels or programs. For example, the system 200 can create groups associated with particular genres of content (such as news-related content, adventure-related content, comedy-related content, children-related content, and so on). Or the system 200 can create groups associated with particular artists (such as content that features a particular artist). Or the system 200 can create groups associated with particular ratings (such as G-rated content, PG-rated content, and so on). Still other bases for grouping channels and programs are possible. In response to an instruction to provide a group-related media presentation 220, the page supplying system 218 creates an MPD 228 that includes identifiers that reference channels or programs associated with a particular topic. The page display module 232 then produces the media presentation 220 based on the MPD 228 in the manner described above.

The above examples are representative. The system 200 can be applied to yet other scenarios.

In closing, although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method for presenting media content, comprising:
receiving page design data;
creating a page definition, based on the page design data, that is customized for a target client device, the page definition including at least one reference to a media stream; and
providing the page definition to the target client device, wherein the target client device uses the page definition to access the media stream identified by said at least one reference, and to present the media stream in a manner specified by the page definition,
wherein the page definition comprises declarative markup content, and wherein said at least one reference comprises information within the declarative markup content that identifies the media stream.

2. The method of claim 1, wherein the declarative markup content comprises HTML information.

3. The method of claim 1, further comprising converting the page definition to a modified form prior to providing the page definition to the target client device, wherein the modified form accommodates a processing capability of the target client device.

4. The method of claim 1, wherein the received page design data pertains to a locale associated with the target client device, and wherein the media stream identified by said at least one reference is associated with a locale-specific media resource.

5. The method of claim 1, wherein the received page design data reflects a media resource recently consumed by the target client device, and wherein the media stream identified by said at least one reference is associated with the recently consumed media resource.

6. The method of claim 1, wherein the received page design data reflects a media resource identified by a user as a favorite, and wherein the media stream identified by said at least one reference is associated with the favorite media resource.

7. The method of claim 1, wherein the received page design data reflects a popularity of a collection of media resources, and wherein the media stream identified by said at least one reference is associated with an assessed popular media resource.

8. One or more machine-readable media containing machine-readable instructions for implementing the method of claim 1.

9. A method for presenting media content at a target client device, comprising:
providing page design data to a page creation module;
at the target client device:
receiving a page definition from the page creation module that is customized, based on the page design data, for the target client device, the page definition including at least one reference to a media stream;
using the page definition to access the media stream identified by said at least one reference; and
presenting the media stream in a manner specified by the page definition,
wherein the page definition comprises declarative markup content, and wherein said at least one reference comprises information within the declarative markup content that identifies the media stream.

10. The method of claim 9, wherein the declarative markup content comprises HTML information.

11. The method of claim 9, wherein the accessing of the media stream comprises virtually tuning to a source of the media stream.

12. The method of claim 9, wherein said at least one reference comprises plural references to plural respective media streams.

13. The method of claim 9, wherein the provided page design data pertains to a locale associated with the target client device, and wherein the media stream identified by said at least one reference is associated with a locale-specific media resource.

14. The method of claim 9, wherein the provided page design data reflects a media resource recently consumed by the target client device, and wherein the media stream identified by said at least one reference is associated with the recently consumed media resource.

15. The method of claim 9, wherein the provided page design data reflects a media resource identified by a user as a favorite, and wherein the media stream identified by said at least one reference is associated with the favorite media resource.

16. The method of claim 9, wherein the provided page design data reflects a popularity of a collection of media resources, and wherein the media stream identified by said at least one reference is associated with an assessed popular media resource.

17. One or more machine-readable media containing machine-readable, instructions for implementing the method of claim 9.

18. A system for presenting media content, comprising:
a page supplying system configured to:
receive page design data;
create a page definition, based on the page design data, that is customized for a target client device, the page definition including at least one reference to a media stream; and
provide the page definition to the target client device, wherein the target client device uses the page definition to access the media stream identified by said at least one reference, and to present the media stream in a manner specified by the page definition,
wherein the page definition comprises declarative markup content, and wherein said at least one reference comprises information within the declarative markup content that identifies the media stream.

19. The system of claim 18, further comprising a content delivery system configured to provide the media stream identified by said at least one reference to the target client device.

20. One or more machine-readable media containing machine-readable instructions for implementing the system of claim 18.
